(19) United States
(12) Patent Application Publication
(10) Pub. No.: US 2007/0088955 A1
(43) Pub. Date: Apr. 19, 2007

(54) Apparatus and method for high speed detection of undesirable data content

(76) Inventors: Tsern-Huei Lee, Fremont, CA (US); Jo-Yu Wu, Sunnyvale, CA (US)

Correspondence Address: CARLTON FIELDS, PA, 1201 WEST PEACHTREE STREET, 3000 ONE ATLANTIC CENTER, ATLANTA, GA, 30309, US

(21) Appl. No.: 11/237,335

(22) Filed: Sep. 28, 2005

(51) Int. Cl. H04L 9/00

(52) U.S. Cl. 713/176

(57) ABSTRACT

An apparatus and method for identifying undesirable data received from a data communication network. The apparatus includes a data receiver, a database, and a content search unit. The content search unit transitions among a plurality of internal states depending on the received data. A predetermined segment of the received data compared with a state table for a current state of the content search unit. If there is a match, the content search unit moves to a next valid state. If there is no match, the content search unit moves to a failure state. When the content search unit reaches a final state, the undesirable data is identified.

### BACKGROUND OF THE INVENTION

1. Field of the Invention

The present invention generally relates to data communications, and more specifically, relates to a system and method for providing security in during data transfers.

2. Description of the Related Art

Computer viruses and worms have caused millions dollars in computer and network downtimes and they made computer virus detection and elimination a thriving industry. Now, every computer is equipped with computer virus detection and prevention software, and every data network gateway is guarded with equally powerful virus detection and prevention software.

Computer virus, bugs, and worms are undesirable software developed by computer hackers or computer whiz kids, who are either testing their programming skills or having other ulterior motives. Like any software, each of these undesired viruses, bugs and worms have a unique digital signature. Once a virus became know, its digital signature is cataloged and made public. Once a virus's signature is known, computer virus prevention software can test incoming data in a data stream for this particular signature. If an incoming data contains this signature, then it is flagged as undesirable data and rejected.

The computer virus prevention software tests an incoming data against signatures of all known viruses, which number is in tens of thousands and still growing. Comparing each incoming data against a growing database of known viruses can demand computing powers and memory resources. The viruses are usually represented by strings or simple regular expressions and the representation of all these strings and simple regular expressions yields to a data structure with low memory-usage efficiency. Checking viruses through this low memory efficiency data structure makes comparison less efficient.

Therefore, it is desirous to have an apparatus and method that provide a high performance memory efficient virus detection system for a data communication system, and it is to such apparatus and method the present invention is primarily directed.

### SUMMARY OF THE INVENTION

Briefly described, an apparatus and method of the invention provide a high performance memory efficient virus detection system for a data communication system. In one embodiment, there is an apparatus for identifying undesirable data in a data stream, wherein the data stream is received from a network and may contain undesirable data, each undesirable datum being identified by a unique data signature. The apparatus includes a data receiver for receiving data from a data source, and a content search unit capable of analyzing the received data. The content search unit has a plurality of internal states and transitions between the plurality of the internal states according to the analysis of the received data. Each internal state is associated with a state table, and the state table provides a plurality of next states consecutively numbered. When the content search unit transitions to an internal state identified as a final state for an undesirable data, the content search unit identifies the undesirable data.

In another embodiment, there is provided a method for a computing device to identify undesirable data in a data stream, wherein the data stream is received from a network and may contain undesirable data. Each undesirable datum is identified by a unique data signature stored in a database, and the computing device transitions among different internal states depending on the data stream and undesirable data. The method includes the steps for a) taking a segment of the data stream using a mask, b) analyzing the segment against a state table, c) if there is a match, moving to a next state, d) if the next state is not a final state, repeating steps a) through d), and e) if the next state is a final state, identifying the undesirable data.

In yet another embodiment, there is provided a method for assembling a matrix to represent a finite state machine for identifying target data in a data stream. Each target datum has a plurality of segments. The matrix has a plurality of columns, a plurality of rows, and a plurality of matrix elements, where each matrix element is identified by a column and a row, each row represents a state in a finite state machine, and each column represents an input. The finite state machine has a current state and transitions to a next state according to the input. The method includes associating each segment of a target datum with an input, assigning a next state to a matrix element according to the current state and the input associated with the matrix element if the rest of segments of the target datum associated with the input is not unique, and assigning a comparison routine to a matrix element according to the current state and the input associated with the matrix element if the rest of segments of the target datum associated with the input is unique.

The present system and methods are therefore advantageous as they enable rapid identification of viruses in a data communication system. Other advantages and features of the present invention will become apparent after review of the hereinafter set forth Brief Description of the Drawings, Detailed Description of the Invention, and the Claims.

### BRIEF DESCRIPTION OF THE DRAWINGS

FIG. 1 illustrates a prior art representation of a sparse vector representing an entry of a state table.

FIG. 2 is an illustration of a state table for each state i of a finite state machine.

FIG. 3 illustrates an example of determining a next valid state.

FIG. 4 is an exemplary flow chart of a virus identification process.

FIGS. 5-7 illustrate an example for checking incoming data using the invention.

FIG. 8 illustrates a transition for a failure function.

FIG. 9 illustrates an exemplary architecture of a system supporting the invention.

FIG. 10 illustrates a goto graph representing state transitions for detecting target data by a finite state machine.

FIG. 11 illustrates a goto graph with reduced states representing the same transitions of FIG. 10.

### DETAILED DESCRIPTION OF THE INVENTION

In this description, the term “application” as used herein is intended to encompass executable and nonexecutable software files, raw data, aggregated data, patches, and other code segments. The term “exemplary” is meant only as an example, and does not indicate any preference for the embodiment or elements described. Further, like numerals refer to like elements throughout the several views, and the articles “a” and “the” includes plural references, unless otherwise specified in the description.

In overview, the present system and method provide a high performance memory efficient virus detection system for a data communication system. The idea of “a banded-row format” has been applied to virus/worm signature matching that implements the Aho-Corasick algorithm. The Aho-Corasick algorithm is commonly implemented through a finite state machine. When checking a data against viruses, a finite state machine for the data transitions between different states depending on the result of comparisons of the data against known viruses. When a segment of the data matches a segment of a virus, the state machine for the data transitions to a valid next state. If there is no match between the segment of the data and the segment of the virus, the state machine for the data transitions to a failure state. The process of comparing and transitioning repeat the entire data has been compared or a virus has been identified. If the state machine reaches a valid final state, then a virus has been identified. If the state machine remains in a non-final state at the end of the data, no known virus was identified in the data.

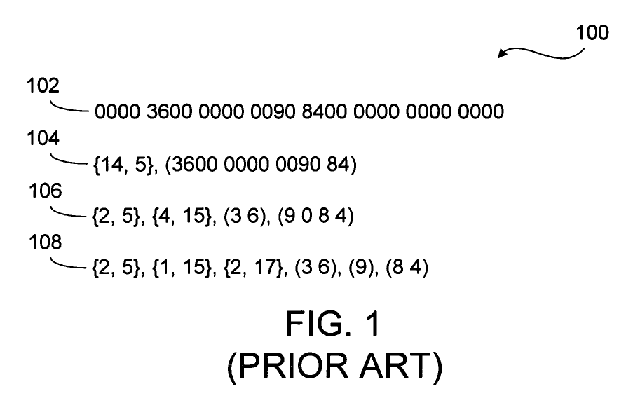

FIG. 1 illustrates a prior art representation 100 of a sparse vector 102 representing an entry of a state table. The vector 102 contains 32 entries where many of the entries are 0's. The representation of the sparse vector can be improved by using the “Banded-Row Format.” The vector 104 is another representation of the entry using only one band representation, where the first number 14 is the width of the band, the second number 5 means that the first non-zero value occurs at position 5, and the following 14 numbers form the shortest sub-vector of the original vector that includes all non-zero values. The vector 106 is a two band representation of the entry, where the first number pair, i.e., {2, 5}, represent the width and the position of the first non-zero value of the first band; the second number pair, i.e., {4, 15} bear similar meanings for the second band; and the following two sub-vectors are, respectively, the values in the first and the second bands. Similarly, the vector 108 is a three band representation of the same entry.

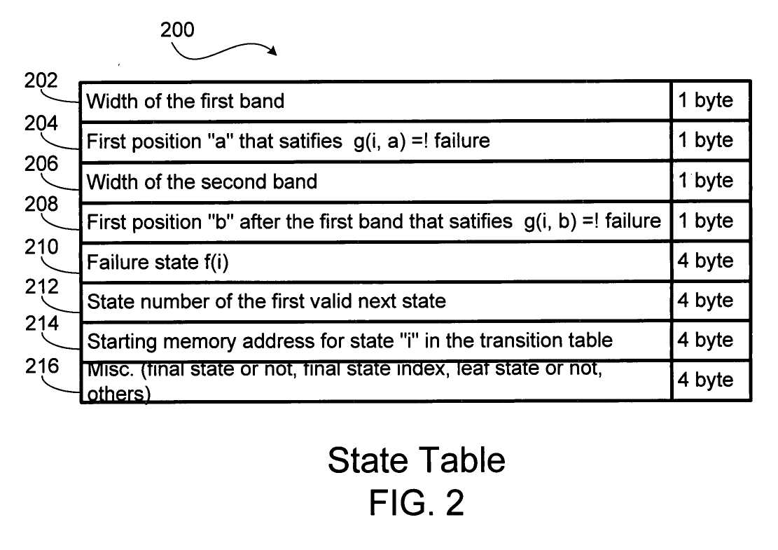

The implementation of the finite state machine is often made impossible because of huge number of states for an ever increasing virus database. The invention presents a special arrangement of states such that the finite state machine is implemented in memory-efficient manner. FIG. 2 is an illustration of a state table 200 for each state i of a finite state machine in a two band representation according to one embodiment of the invention. The entry 202 stores the width of the first band and entry 204 contains a first position with a valid next state. The entry 206 stores the width of the second band and entry 208 contains a first position after the first band with a valid next state. The entry 210 specifies the failure state for state i and entry 212 specifies the state number for the first valid next state. The entry 214 specifies the memory address for state i in the transition table and the entry 216 stores miscellaneous (Misc.) information.

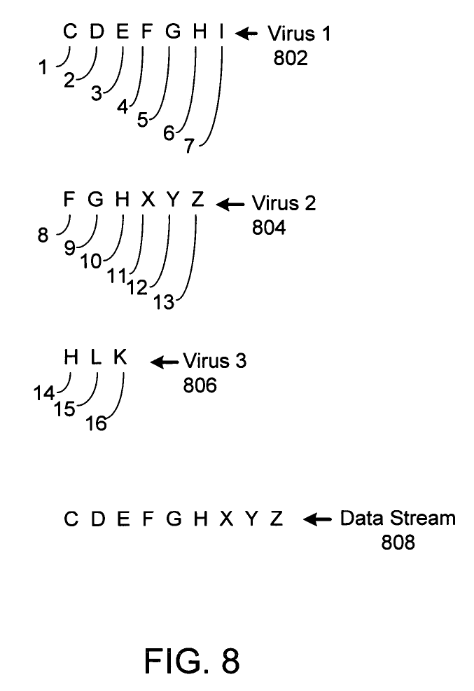

It is noted that the 4 bytes allocated to a miscellaneous (Misc) field may not be needed because it is likely to have un-used bits in the “Failure state” and the “State number of the first valid next state” fields. In fact, using 3 bytes for state number can represent a total of 16M states and thus should be more than enough. Assuming that the 4 bytes allocated to Misc. field is saved, it is needed 16N bytes for a pattern matching machine with N states. If N=5M (say, for 50K signatures with an average of 100 states per signature), then the storage requirement is 80M bytes for the State Table. It is noted that the State Table implements a failure function and indicates whether or not state i is a final state, i.e., a state with non-empty output function. The failure function maps a state to another state and is discussed in more detail in FIG. 8.

Another array, called Transition Table, is necessary to implement a transition function. An “offset” for each “state number of the first valid next state” is stored in the Transition Table. For each state i, its valid next states can be numbered with consecutive integers so that the exact next state can be determined with “state number of the first valid next state” stored in the State Table and “offset” stored in the Transition Table. By arranging the valid next states consecutively, the memory usage to represent the state information and transition can be greatly reduced with help of a Transition Table.

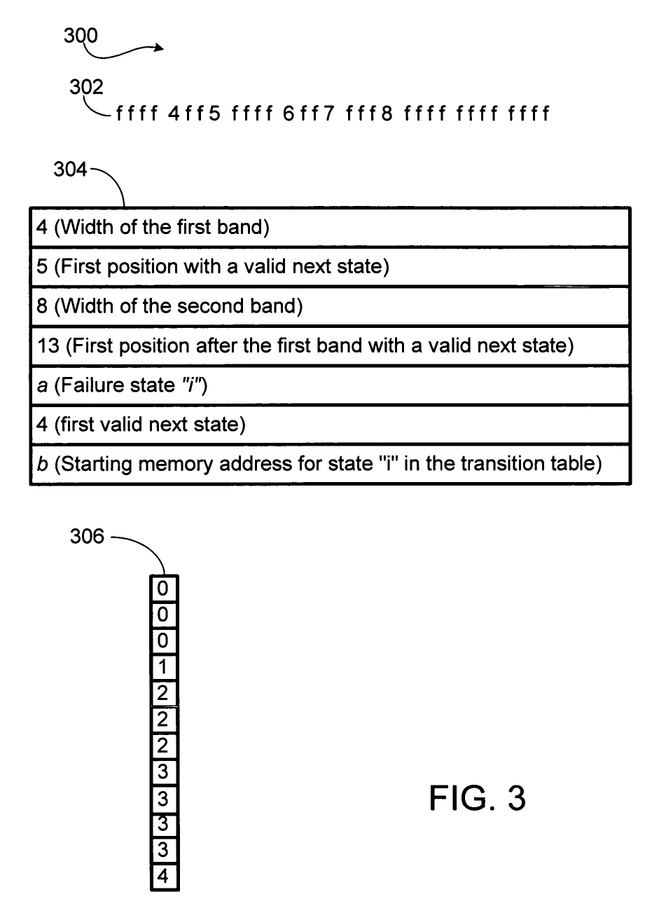

FIG. 3 illustrates an example of determining a next valid state using the State Table and Transition Table. The valid next states are arranged in such way that when they are represented by a sparse vector 302, they are consecutively numbered. For example, the sparse vector 302 is illustrated with consecutive valid next states. The sparse vector 302 illustrates transitions for state i, where f represents the failure state. Assume further that f(i)=a and the starting memory address for state i in the Transition Table is b. As a result, for state i, the State Table 304 for state i is illustrated and the Transition Table 306 for state i is also illustrated.

The sparse vector 302 is also represented by the State Table 304. The width of the first band is 4; the first position with a valid next state is position 5. The first band would then include (4 f f 5). The width of the second band is 8; the first position after the first band with a valid state is position 13. The second band would then include (6 f f 7 f f f 8). The failure state would be “a” and the first valid next state is 4. There will be a Transition Table associated with this state table and the transition table would be stored at memory location “b.”

It is noted that the total number of entries in the Transition Table 306 for state i is equal to the sum of the widths of its two bands. Each entry corresponds to an input symbol in band 1 or band 2. The first offset corresponds to the first symbol with a valid next state and is always a zero. The offset increases by one, compared to the value stored in the entry immediately above, if and only if the corresponding symbol results in a valid next state, i.e., the output of the transition function is not the failure message.

Let x and y denote the starting symbols of band 1 and band 2, respectively. To determine the next state for state i with input symbol z, we need to check if symbol z is in band 1, band 2, or neither. If it is not in any of the two bands, then we have g(i,z)=failure and the process repeats after replacing the current state with the failure state stored in the State Table 304. Assume that input symbol z is in band 1. In this case, the offset stored in the (z−x+1)th entry is compared with the offset stored in the (z−x)th entry (we assume that the offset stored in the (−1)th entry is a −1). If the two offsets are identical, then we have g(i,z)=failure and the process is repeated with f(i) as the current state. If the two offsets are different, then we have g(i,z)=the first valid next state (stored in the State Table)+the offset stored in the (z−x+1)th entry. The process for input symbol z in band 2 is similar. The only difference is that the entry corresponding to symbol z becomes (width of band 1)+(z−y+1). For the above example, if input symbol is “14”, then the offset is 2 (the 6^{th} entry (width of band 1+(14−13+1) in the Transition Table). Since the value of the 5^{th} entry is also 2, the outcome is a failure message. If the input symbol is “16”, then the offset is 3 (the 8^{th} entry) which is different from the offset stored in the 7^{th} entry, and thus the next state is given by g(i, 16)=5 (first valid next state)+3 (offset)=8.

In other words, the State Table 304 and Transition Table 306 are used to determine valid next states. From State Table 304, the first valid next state is determined to be 4 and it is at position 5. Therefore, if an input is 5, from the State Table, the next state would be 4. If the input is 8, from the State Table, it is learned that the first position with a valid state is position 5 and the width of the first band is 4; therefore the first band covers position 8, and it is needed to check if position 8 has a valid next state. From the Transition Table, the first entry corresponds to position 5 (first position with a valid next state) and it is 0. The second entry corresponds to position 6 and it is also 0; the third entry corresponds to position 7 and it is another 0. When the entry in the Transition Table corresponding to a particular position has an entry that is identical to the entry in the previous position, it means that the next state for this position in the State Table is a failure state, i.e., not a valid state. If the entry in the Transition Table corresponding to a particular position has an entry that is different from the entry in the previous position, it means that the next state for this position in the State Table is a valid state. For the case of input 8, the entry in the Transition table corresponding to position 8 is 1, which is different from the entry for the previous position. Therefore, the next state is a valid state and its value is determined by adding the entry, which is 1, to the previous valid state, which is 4, and the valid state will then be 5.

Below is an analysis of memory requirement for using the State Table and Transition Table. For 8-bit input symbols, it is clear that an entry of the Transition Table requires 1 byte. Let W represent the average size of the sum of the widths of band 1 and band 2. As a result, the storage requirement of the Transition Table is NW bytes. Assuming that N=5M and W=20, we have NW=100M bytes.

Combining the State Table and the Transition Table, it is needed about 180M bytes memory to realize the Aho-Corasick algorithm for N=5M states. Note that output function is not included. Since it is unlikely for any virus signature to be a suffix or a factor of another one, the output contains only one signature if there is a match. As a result, the memory requirement for the output function is approximately 2N bytes because all it is needed is to store the signature ID for every final state. To allow flexibility, 2 bytes can be used to store the final state index in the State Table (resulting in a State Table of size 20N bytes or 100M bytes if N=5M) and another array, called Final State Table, to store the IDs of matched signatures. For each final state, it is stored the number of matched signatures and their IDs. Let K and L denote, respectively, the number of final states and the average number of matched signatures for each final state. As a result, the memory requirement for the Final State Table is given by (2L+1)K bytes because one byte is needed to store the number of matched signatures and 2 bytes for every signature ID. It is expected K to be close to N and L a small number (should be very close to 1). Therefore, a memory size of 20M bytes should be enough to implement the output function for N=5M. To summarize, the memory requirement should be less than 220M bytes for N=5M.

A straightforward approach to implement the transition function is to create an N×256 matrix. Each entry requires more than 6 bytes to represent the next state, indicate whether or not a state is a final state, and the index if it is a final state. Consequently, the memory requirement for this solution is at least 7.5G bytes for N=5M. One advantage of such an implementation is high speed because it iteratively applies the failure function until a valid next state is found.

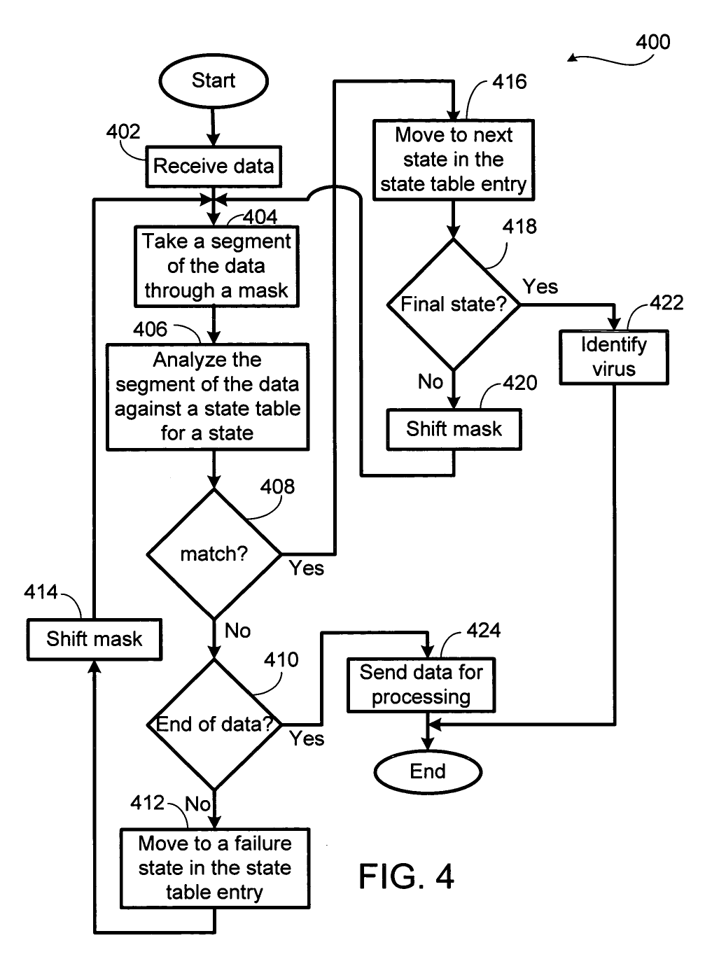

FIG. 4 is an exemplary flow chart 400 of a virus identification process using State and Transition Tables. When a new incoming data is received, step 402, the finite state machine is reset to state zero. A segment of the data is taken through a mask, step 404, and analyzed against the State Table for the state zero, step 406. If there is not match, it is checked whether it is at the end of the incoming data, step 410. If it is not at the end of the incoming data, the finite state machine moves to the failure state indicated in the State Table, step 412, the mask is shifted, step 414, a new segment of the incoming data is taken and the process repeats itself. If it is at the end of the incoming data, then no virus is found in the incoming data and the incoming data is sent for other processing, step 424.

If there is a match when comparing with the State Table, the finite state machine moves to a next valid state specified by the State Table, step 416. It is checked whether it is at a final state, step 418. If the finite state machine finds itself at a final state, it identifies the virus, step 422. If the next valid state is not a final state, then the mask is shifted, step 420, and a new segment of the incoming data is taken and the process repeats itself.

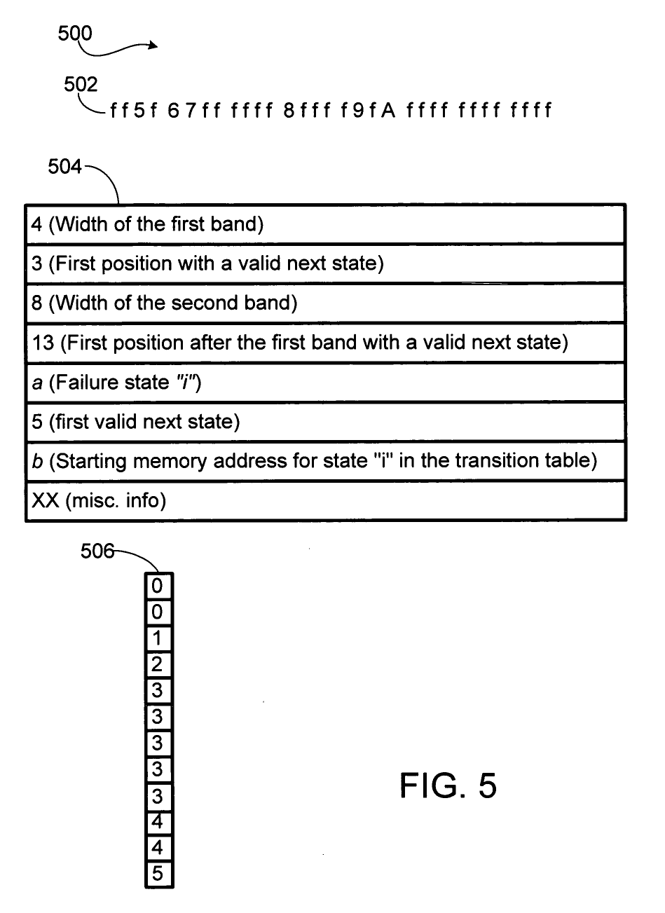

The following is an example based on the information illustrated in FIG. 5. Now, let's say that one of the viruses has a signature that is 51 and the input is 2 5 1 X X, where X denotes “don't care condition.” The State Table 504 and Transition Table 506 are for state zero (initial state) and the data in these tables depend on virus signatures. A mask is used to take a segment of the data for analysis. The segment taken is “2” and it is checked against the State Table 504 for state zero. The State Table tells us that state zero is not a final state and the first valid next state is 5 and it is at 3rd position; “2” matches to the 2nd position, which will lead to state zero. So the state does not change for input “2.”

The next input data checked is “5” and “5” matches to position 5. From the State Table 504, it is shown that the first position with a valid next state is 3^{rd} position and the bandwidth is 4, which covers up to position 6. Therefore, we have to check the Transition Table 506. From the State Table 504, the first valid next state is 5, and from the Transition Table 506 it is shown (5+0) for position 3, (5+0) for position 4, (5+1) for position 5, and (5+2) for position 6. The position of interests is position 5, and from the Transition Table 506 it is shown that there is a valid next state for position 5 and the valid next state for position 5 is state 6. So the finite state machine moves to state 6.

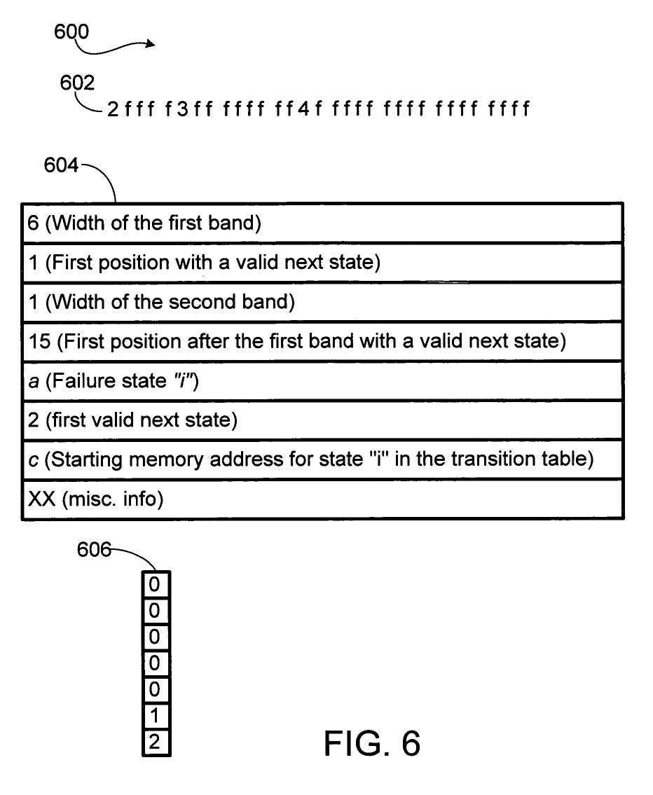

FIG. 6 illustrates a vector 602, State Table 604, and Transition Table 606 for state 6. The failure state f for state 6 can be any state, depending on virus signatures, including state zero. The next data to be checked is “1” of 2 5 1 X X. The State Table 604 shows the position for the first valid state is position 1, which the data maps in, and the first valid next state is “2.” From the Transition Table 606, it can be seen, (2+0) for position 1, and the next state is state 2. So the finite state machine moves to state 2 and prepares to check “X” (which is a don't care).

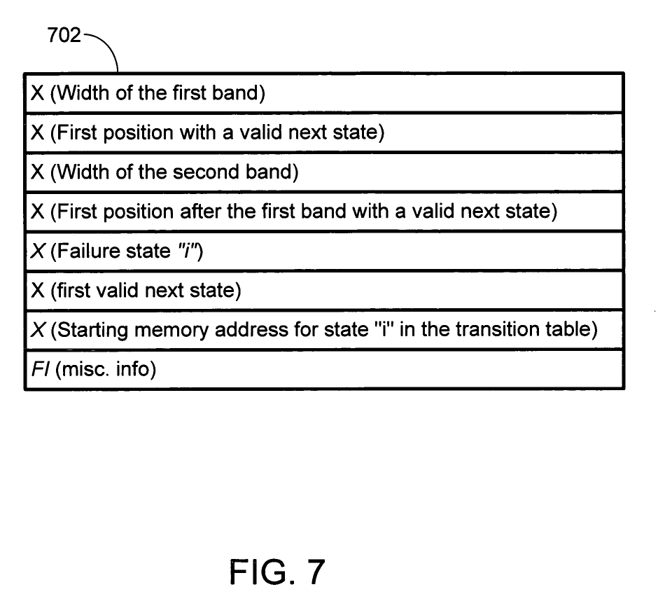

FIG.7 illustrates a State Table 702 for state 2. The State Table 702 for state 2 indicates that state 2 is a final state for virus Fl. Therefore, the virus Fl has been identified. A Transition Table is not needed for any final state if the goal is to detect the first occurrence of some virus. However, if the goal is to detect all occurrences of viruses, or keywords in other applications such as anti-spam, then a Transition Table would be needed for a final state.

The size of bands should be determined to minimize the size of transition table. For example, consider a vector, 2fff f3ff ffff ff4f ffff ffff ffff, if “3” is considered as part of band 1, then the size of transition table is 6 (width of band 1)+1 (width of band 2)=7. On the other hand, if “3” is considered as part of band 2, then the size of transition table becomes 1 (width of band 1)+10 (width of band 2)=11. So, the former choice is a better choice in the sense of minimizing storage requirement. Note that the idea is not limited to two bands. It can be easily generalized to more than two bands.

Some prefix of one virus signature may contain the prefix of another virus signature as a proper suffix. For example, let's assume the signature of virus #1 is 5 6 4 8 and the signature of virus #2 is 6 4 9 3. Note that the prefix “5 6 4” of virus signature #1 contains the prefix “6 4” of virus signature #2 as a suffix. When checking input 2 5 6 4 9 3 6, the first input data “2” does not match any prefix of the two signatures and, therefore, the finite state machine stays in state zero. The next three input characters make the finite state machine enter a valid state that indicates matching of the prefix “5 6 4” of virus signature #1. However, the fifth input character “9” results in failure and the failure state should be some state that indicates match of the prefix “6 4” of virus signature #2. After entering the failure state, the input character “9” is examined again. After one more input character is examined, the finite state machine finds a match of virus signature #2.

It is possible that there is more than one possible next state for a failure state because multiple viruses share a common prefix. FIG. 8 illustrates an example of a failure function when three viruses 802, 804, 806 share some common signature. When scanning an input data stream 808, the finite state machine starts from state 0, checks the first input, C, which matches an element of virus 802, the finite state machine then moves to state 1. The process continues through inputs D, E, F, G, and H, and the finite state machine transitions from state 1, through states 2, 3, 4, 5, to state 6. When the next input X is read, it does not match the expected element, I, and a failure occurs. From state 6, when H is checked, the finite state machine can transition to either state 10 for virus 804 or state 14 for virus 806. The failure function of state 6 will take the finite state machine to a next state that reflects the shortest string which leads from a start state to state “r” is the longest proper suffix of the shortest string that leads the finite state machine from the start state to state “s.” In this case, there are two possible proper suffixes for state 6, which are “F G H” and “H” and the longest proper suffix for state 6 is “F G H.” Therefore, the proper next state is state 10 of virus 804 and the finite state machine continues transitions to state 10 of virus 804.

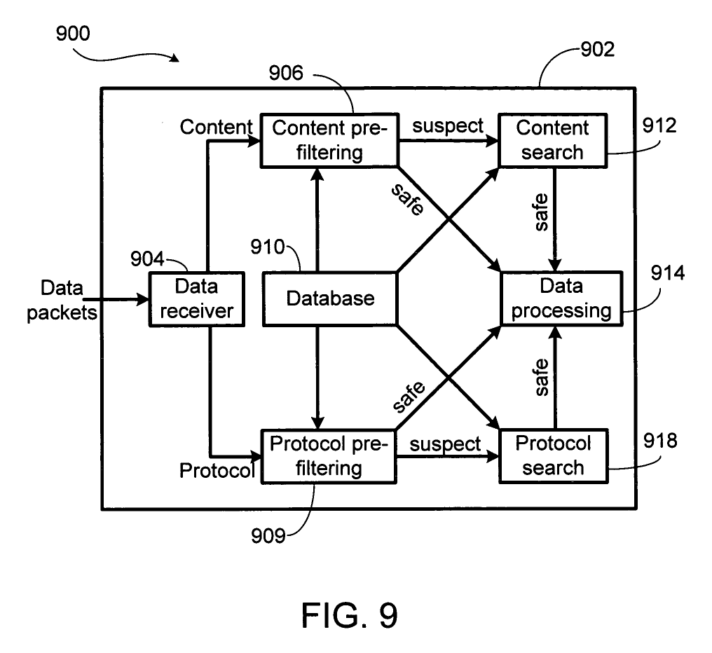

FIG. 9 illustrates an exemplary architecture 900 of a system 902 supporting the invention. Data packets for an application are received from a network are processed and placed in order by a data receiver 904. The protocol portion of the data is sent to a protocol pre-filtering unit 908 and the content portion of the data is sent to a content pre-filtering unit 906. If the incoming data is identified as a suspect data possibly containing undesirable data, it is then sent to a content search unit 912, where the content will be fully searched against all known viruses from a database 910. Alternatively, the incoming data may also be analyzed directly by the content search unit 912 instead of analyzed first by the content pre-filtering unit 906. The database 910 may contain virus information and the state information for the content search unit 912. The content search unit 912 is a finite state machine and performs content search analysis using methods described in supra paragraphs. If the content is found to be safe, it is forwarded to a data processing unit 914. If the content is found to have virus, it is quarantined and may be destroyed. The database 910 should be constantly updated with the latest virus information and the state information should also be updated accordingly. Other elements, such as a controller and input/output units, not essential to the description of content search are not illustrated and described here.

It should be noted that the invention is not limited to identifying undesirable content in a data stream; the invention is equally useful for general string matching applications, such as control of confidential information and search of data with specific characteristics. For example, a corporation can embed sensitive documents with certain control strings and then later use the methods of the invention to screen all outgoing electronic mails to prevent unauthorized transmission of the sensitive documents to outside parties.

The methods and finite state machine illustrated above can be implemented through matrices and the size of each matrix reflects the number of states and number of target data that the finite state machine is identifying. For example, the number of rows of the matrix reflects the number of states, the number of columns reflects the number of segments of target data, and each element of matrix reflects a pointer to a next state. The size of matrices can be large because of the number of segments of target data is generally large. Consequently, a large memory resource is required to implement a matrix. However, the size of a matrix can be reduced and the memory usage reduced by following techniques described below.

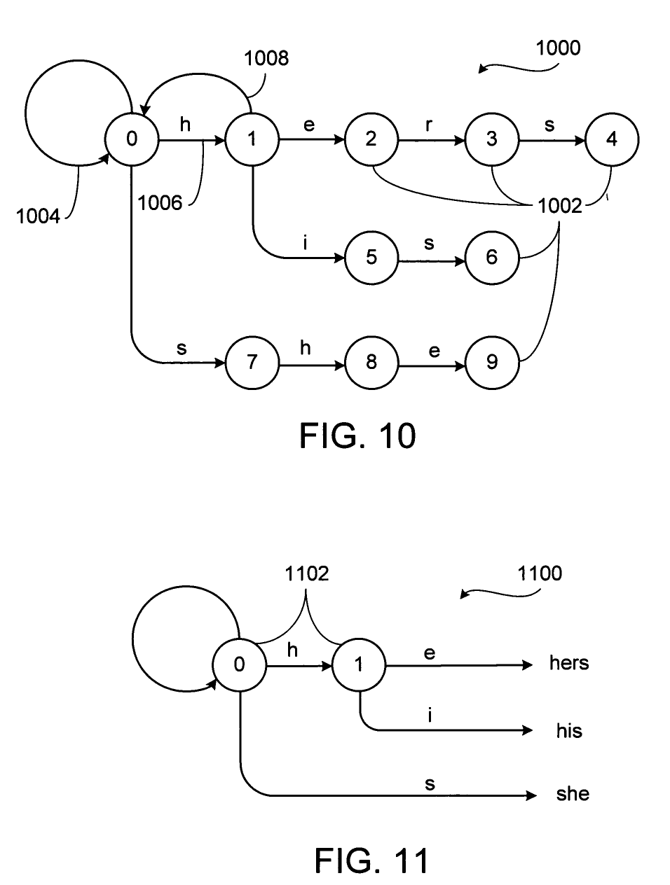

FIG. 10 illustrates a transition graph 1000 for a finite state machine looking for certain indication of presence of a target data. The finite state machine has 10 internal states 1002, where each internal state is represented by a circle labeled with a number. The finite state machine starts at state 0 and the data it is looking for are {hers, his, she}. At state 0, if a “h” is received, the finite state machine transitions to state 1, as indicated by arrow 1006. If a “s” is received, the finite state machine transitions to state 7, and for any other input received, the finite state machine remains at state 0 as indicated by arrow 1004.

If the next input received, after the finite state machine transitions to state 1, is “e,” then the finite state machine transitions to state 2. If the next input received is “i,” then the finite state machine transitions to state 5. If the next input is anything other than “e” or “i,” then there is a failure and the finite state machine moves back to the original (idle) state 0 as indicated by arrow 1008. For simplicity, all other transitions from other states back to the state 0 are omitted. When the finite state machine reaches final states 4, 6, or 9, then the target datum associated with that final state is identified. For example, if the final state is state 9, then the identified target data is “she.”

FIG. 10, which is an example of a goto graph, can also be described in the following terms. State j is said to be a descendent state of state i if there is a path from state i to state j, i.e., there exist states i₁, i₂, i₃, . . . , iₙ such that state i₁ is a valid next state of state i, state i₂ is a valid next state of state i₁, . . . , state iₙ is a valid next state of state iₙ₋₁, and state j is a valid next state of state iₙ. Note that state j is a descendent state of itself. A state is a leaf state if it has no descendent state other than itself. The sub-tree of state k is defined to be the tree which consists of state k and all its descendent states. A sub-tree is called a simple branch if every state in the sub-tree, except the leaf state, has exactly one valid next state.

The idea to further reduce the memory usage is to prune all the simple branches of the goto graph illustrated in FIG. 10. Note that in each leaf state i of a pruned goto graph, there is a pointer pointing to the corresponding byte position of the longest signature which contains the string represented by state i as a prefix. FIG. 11 illustrates the pruned goto graph of FIG. 10. The goto graph 1100 illustrated in FIG. 11 takes advantage of certain characteristics of unique to each target datum. From FIG. 10, it can be observed that, if an input “e” is received at state 1, the target datum “hers” will be identified only if next inputs are “r” and “s.” Thus, the finite state machine needs not to transition from state 2, to state 3, and finally to state 4 to identify the target datum “hers.” Instead, at state 1 when input “e” is received, the finite state machine can immediately check whether next inputs are “r” and “s,” thus eliminating states 2, 3, and 4. Similar checking can be done for input “i” at state 1 and input “s” at state 0. FIG. 11 illustrated the goto graph pruned accordingly. Comparing FIG. 10 and FIG. 11, it can be seen that the number of states has been reduced from 10 to 2. In the matrix representing the goto graph 1100, when the finite state machine is at state 1 and input “e” is received, instead of transitioning to state 2 as illustrated in FIG. 10, the finite state machine invokes a procedure or comparison routine to check for the target datum “hers.”

In view of the method being executable on networking devices, the method can be performed by a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a networking computer platform, such as a magnetic disk or tape, optical disk, hard disk, flash memory, or other storage media as is known in the art.

In the context of FIG. 4, the steps illustrated do not require or imply any particular order of actions. The actions may be executed in sequence or in parallel. The method may be implemented, for example, by operating portion(s) of a network device, such as a network router or network server, to execute a sequence of machine-readable instructions. The instructions can reside in various types of signal-bearing or data storage primary, secondary, or tertiary media. The media may comprise, for example, RAM (not shown) accessible by, or residing within, the components of the network device. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

What is claimed is:

1. An apparatus for identifying undesirable data in a data stream, wherein the data stream is received from a network and may contain undesirable data, each undesirable datum being identified by a unique data signature, comprising:
a data receiver for receiving data from a data source; and
a content search unit capable of analyzing the received data, the content search unit having a plurality of internal states and transitioning between the plurality of the internal states according to the analysis of the received data, each internal state being associated with a state table, the state table providing a plurality of next states consecutively numbered,
wherein when the content search unit transitions to an internal state identified as a final state for an undesirable data, the content search unit identifies the undesirable data.

2. The apparatus of claim 1, wherein the each internal state further being associated with a transition table, the transition table having a sequence of a plurality of numerical identifiers, when a current numerical identifier is different from a previous numerical identifier, the current numerical identifier identifies a valid next state.

3. The apparatus of claim 2, wherein the current numerical identifier is the same as the previous numerical identifier, the current numerical identifier identifies an invalid next state.

4. The apparatus of claim 1 further comprising a database, the database containing undesirable data and the state tables for each internal state of the content search unit.

5. The apparatus of claim 1, wherein the data receiver is capable of ordering the received data.

6. The apparatus of claim 1, wherein state transitions for each internal state can be represented by a vector, which is divided into a plurality of bands, and the state table for each internal state further comprising a plurality of entries that include widths of each band and a first valid next state.

7. A method for a computing device to identify undesirable data in a data stream, wherein the data stream is received from a network and may contain undesirable data, each undesirable datum being identified by a unique data signature stored in a database, the computing device transitions among different internal states depending on the data stream and undesirable data, comprising the steps for:
a) taking a segment of the data stream using a mask;
b) analyzing the segment against a state table;
c) if there is a match, moving to a next state;
d) if the next state is not a final state, repeating steps a) through d); and
e) if the next state is a final state, identifying the undesirable data.

8. The method of claim 8, further comprising the step for, if there is no match, moving to a failure state.

9. The method of claim 9, further comprising the steps for:
checking for end of the data stream; and
if the segment is the end of the data stream, sending the data stream for processing.

10. A computer-readable medium on which is stored a computer program for a computing device to identify undesirable data in a data stream, wherein the data stream is received from a network and may contain undesirable data, each undesirable datum being identified by a unique data signature stored in a database, the computing device transitions among different internal states depending on the data stream and undesirable data, the computer program comprising computer instructions that when executed by a computing device performs the steps for:
a) taking a segment of the data stream using a mask;
b) analyzing the segment against a state table;
c) if there is a match, moving to a next state;
d) if the next state is not a final state, repeating steps a) through d); and
e) if the next state is a final state, identifying the undesirable data.

11. The computer program of claim 10, further performing the step for, if there is no match, moving to a failure state.

12. The computer program of claim 10, wherein the step of analyzing the data stream further comprising steps for:
checking for end of the data stream; and
if the segment is the end of the data stream, sending the data stream for processing.

13. An apparatus for identifying undesirable data in a data stream, wherein the data stream is received from a network and may contain undesirable data, each undesirable datum being identified by a unique data signature, comprising:
means for receiving data from a data source; and
means for analyzing the received data, the means for analyzing the received data having a plurality of internal states and transitioning between the plurality of the internal states according to the analysis of the received data, each internal state being associated with a state table, the state table providing a plurality of next states consecutively numbered,
wherein when the means for analyzing the received data transitions to an internal state identified as a final state for an undesirable data, the means for analyzing the received data identifies the undesirable data.

14. The apparatus of claim 13, wherein the each internal state further being associated with a transition table, the transition table having a sequence of a plurality of numerical identifiers, when a current numerical identifier is different from a previous numerical identifier, the current numerical identifier identifies a valid next state.

15. The apparatus of claim 14, wherein the current numerical identifier is the same as the previous numerical identifier, the current numerical identifier identifies an invalid next state.

16. The apparatus of claim 13 further comprising a database, the database containing undesirable data and the state tables for each internal state of the content search unit.

17. The apparatus of claim 13, wherein the means for receiving data is capable of ordering the received data.

18. The apparatus of claim 13, wherein state transitions for each internal state can be represented by a vector, which is divided into a plurality of bands, and the state table for each internal state further comprising a plurality of entries that include widths of each band and a first valid next state.

19. A method for assembling a matrix to represent a finite state machine for identifying target data in a data stream, the matrix having a plurality of columns, a plurality of rows, and a plurality of matrix elements, each matrix element being identified by a column and a row, each row representing a state in a finite state machine, each column representing an input, the finite state machine having a current state and transitioning to a next state according to the input, each target datum having a plurality of segments, the method comprising the steps of:
associating each segment of a target datum with an input;
assigning a next state to a matrix element according to the current state and the input associated with the matrix element if the rest of segments of the target datum associated with the input is not unique; and
assigning a comparison routine to a matrix element according to the current state and the input associated with the matrix element if the rest of segments of the target datum associated with the input is unique.

20. The method of claim 19, wherein the next state is a final state of a target datum if the segment associated with the input is the last segment of the target datum.

21. The method of claim 19, further comprising the step of assigning one row to represent a starting state for each target datum.

22. A matrix representing a finite state machine for identifying target data in a data stream, the finite state machine having a current state and transitioning to a next state according to an input, each target datum having a plurality of segments, each segment of a target datum being associated with the input, comprising:
a plurality of columns, each column representing the input;
a plurality of rows, each row representing a state in a finite state machine; and
a plurality of matrix elements, each matrix element being identified by a column and a row,
wherein a matrix element being associated with a next state according to the current state and the input associated with the matrix element if the rest of segments of the target datum associated with the input is not unique, and
a matrix element being associated with a comparison routine according to the current state and the input associated with the matrix element if the rest of segments of the target datum associated with the input is unique.

23. The matrix of claim 22, wherein the next state is a final state of a target datum if the segment associated with the input is the last segment of the target datum.

24. The matrix of claim 22, wherein one of the plurality of rows to represent a starting state for each target datum.
